(19) United States
(12) Patent Application Publication
(10) Pub. No.: US 2006/0091163 A1
(43) Pub. Date: May 4, 2006

(54) Adjustable metered dosage particulate condiment dispenser

(76) Inventors: Shi Peng, Hong Kong SAR (CN); Chien-Gang Lin, Hong-Kong SAR (CN)

Correspondence Address: Thomas E. Sisson;Jackson Walker, LLP, Suite 2100, 112 E. Pecan, San Antonio, TX, 78205, US

(21) Appl. No.: 11/168,725

(22) Filed: Jun. 29, 2005

Related U.S. Application Data
(63) Continuation of application No. 10/981,025, filed on Nov. 4, 2004.

(51) Int. Cl. G01F 11/10

(52) U.S. Cl. 222/361

(57) ABSTRACT

A dispenser for particulate material, includes a vessel for storing the particulate material, a dispensing head attached to or formed integrally with the vessel, the dispensing head having an port communicating with the vessel, a trigger movable with respect to the head and comprising a plurality of metering compartments that can be brought into alignment with the port upon depression of the trigger. The trigger has a number of steps formed thereon. A user-adjustable stopper is mounted upon the dispensing head and is configured to interact with the steps to selectively limit depression of the trigger to thereby align a selected one or more of said metering compartments with the port.

This application is a continuation-in-part application of co-pending U.S. patent application Ser. No. 10/981,025, filed Nov. 14, 2004.

### BACKGROUND OF THE INVENTION

The present invention relates to condiment dispensers such as salt or pepper shakers. More particularly, although not exclusively, the invention relates to a salt shaker having a storage chamber, an adjustable metered dosage trigger and an arrangement by which excess/leaked salt particles are dispensed by the trigger.

Condiment dispensers for releasing metered particulate materials such as pepper, or herbs and spices are known. Such dispensers are not however known to comprise user-controlled auto-returning dispensing triggers for setting a required dosage of material to be dispensed. Furthermore, such dispensers are not designed with reduced friction, anti-clogging triggers, do not address the problem of excess material build-up around the trigger mechanism and are not airtight—thereby rendering their suitability for prolonged storage of absorptive material low.

### THE OBJECT OF THE INVENTION

It is the object of the present invention to address the above disadvantage and/or more generally to provide an improved particulate condiment dispenser providing user-adjustable metered dispensation of its contents.

### DISCLOSURE OF THE INVENTION

There is disclosed herein a dispenser for particulate material, comprising:

a vessel for storing the particulate material,

a dispensing head attached to or formed integrally with the vessel, the dispensing head having a port communicating with the vessel,

a trigger movable with respect to the dispensing head and comprising a plurality of metering compartments that can be brought into alignment with the port upon depression of the trigger, the trigger having a number of steps formed thereon, and

a user-adjustable stopper mounted upon the dispensing head and configured to interact with the steps to selectively limit depression of the trigger to thereby align a selected one or more of said metering compartments with the port.

Preferably, the dispensing head further comprises a dispensing path via which any excess particulate material can be dispensed.

Preferably, the trigger is mounted to the dispensing head so as to slide linearly therein.

Preferably, the dispensing head comprises a pair of posts onto which a pair of springs is mounted, the springs biasing the trigger into a rest position.

Preferably, the dispensing head comprises a pair of fixed trigger guides, and the trigger has a pair of curved side faces that slide along the respective trigger guides.

Preferably, the dispensing path includes spaces alongside the curved side faces.

Preferably, the dispenser further comprises a separator board positioned beneath the trigger and comprising a main dispensing aperture to be aligned with the metering compartments and a pair of side dispensing apertures laterally flanking the trigger and aligned with the dispensing path spaces, and a rear dispensing aperture aligned with the dispensing chamber.

Preferably, the trigger rests in a retracted position making it possible to fit a cap upon the dispensing head and thereby conceal any openings in the dispensing head through which moist air might pass.

The vessel might be a jar having an externally threaded opening, and further comprising an adapter ring having an internal thread threadedly engaged by the opening of the jar and attached to the dispenser head.

The vessel might alternatively be a can having an opening, and an adapter ring having a clamp secures the adapter ring to the can, and attaches to the dispenser head.

There is further disclosed herein a dispenser for particulate material, comprising:
a vessel for storing the particulate material,
a dispensing head attached to or formed integrally with the vessel, the dispensing head having a port communicating with the vessel,
a trigger movable with respect to the dispensing head and comprising a metering compartments that can be brought into alignment with the port upon depression of the trigger, and
means for inducing a vibration or shock in the trigger upon depression and/or release of the trigger to assist in dispensing the particulate material.

Preferably, said means for inducing a vibration or shock comprises a plurality of notches upon the trigger and/or dispensing head and a pawl on the other of the trigger or dispensing head interacting with said plurality of notches to induce vibration in the trigger upon depression and/or release thereof.

Alternatively, said means for inducing a vibration or shock comprises a plurality of serrations upon the trigger and dispensing head interacting with one another to induce vibration in the trigger upon depression and/or release thereof.

Alternatively, said means for inducing a vibration or shock comprises a ramp on the trigger and a torsion spring mounted on the dispenser head and on which there is provided a wheel interacting with the ramp to ride off an end of the ramp and bump against the trigger upon depression of the trigger.

The dispenser might further comprise a knurled threaded post that interacts with sliding wall blade with a slot and volume markings.

There is further disclosed herein a combination comprising the above-disclosed dispenser, and a metering beaker comprising volume markings which correspond with the volume markings of the dispenser to enable the user to adjust the knurled post to align the sliding wall blade with an appropriate said the dispenser marking, thereby setting a volume capacity of the metering compartment of the trigger for subsequent dispensing dosage size.

### BRIEF DESCRIPTION OF THE DRAWINGS

A preferred form of the present invention will now be described by way of example with reference to the accompanying drawings, wherein:

FIG. 1 is a schematic parts-exploded perspective illustration of an adjustable metered dosage particulate condiment dispenser,

FIG. 2 is a schematic inverted perspective illustration of the dispensing head of the dispenser,

FIG. 3 is a schematic perspective illustration of the dispensing head with internal components removed for illustration purposes,

FIG. 4 is a schematic inverted plan view of the dispensing head of FIG. 3,

FIG. 5 is a schematic cross-sectional elevation of the dispensing head,

FIG. 6 is a schematic plan view of the dispensing head with parts installed therein,

FIG. 7 is a schematic side elevation of a trigger-return spring,

FIG. 8 is a schematic plan illustration of the trigger-return spring,

FIG. 9 is a schematic perspective illustration of the trigger,

FIG. 10 is a schematic cross-sectional elevation of the trigger,

FIG. 11 is the a plan view of the trigger,

FIG. 12 is a schematic perspective illustration of a separator board,

FIG. 13 is a schematic inverted perspective illustration of a trigger having an array of notches,

FIG. 14 is a schematic perspective illustration of an alternative dispensing head into which the trigger of FIG. 13 is received,

FIG. 15 is a schematic cross-sectional elevation of a DIY dosage setting mechanism fixed in one dosage position,

FIG. 16 is a schematic cross-sectional elevation of the DIY dosage setting mechanism fixed in another dosage position,

FIGS. 17 and 18 are schematic plan views of the mechanism of FIGS. 15 and 16,

FIG. 19 is a schematic perspective illustration of a measuring beaker,

FIG. 20 is a schematic inverted perspective illustration of another alternative dispensing head,

FIG. 21 is a schematic perspective illustration of the trigger for use with the dispensing head of FIG. 20,

FIG. 22 is a schematic perspective illustration of a further dispensing head and trigger,

FIG. 23 is a schematic perspective illustration of an alternative dispenser having a hinged lid in a closed configuration,

FIG. 24 is a schematic perspective illustration of the dispenser of FIG. 23 having the hinged lid in an open configuration,

FIG. 25 is a schematic parts-exploded perspective illustration of a glass or plastics jar in combination with an adapter ring and components of a particulate condiment dispenser including a dispensing head,

FIG. 26 is a schematic inverted illustration the adapter ring and dispensing head shown in FIG. 25,

FIG. 27 is a schematic parts-exploded perspective illustration of a metal can in combination with a can-clamping adapter ring and components of a particulate condiment dispenser including a dispensing head, and

FIG. 28 is a schematic inverted illustration the can-clamping adapter ring, can and dispensing head shown in FIG. 27.

### DESCRIPTION OF THE PREFERRED EMBODIMENTS

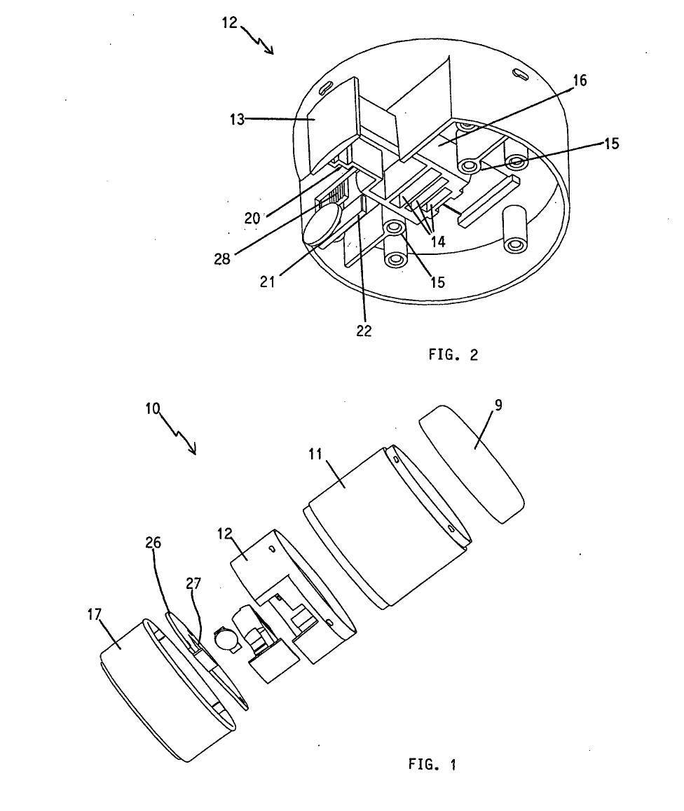

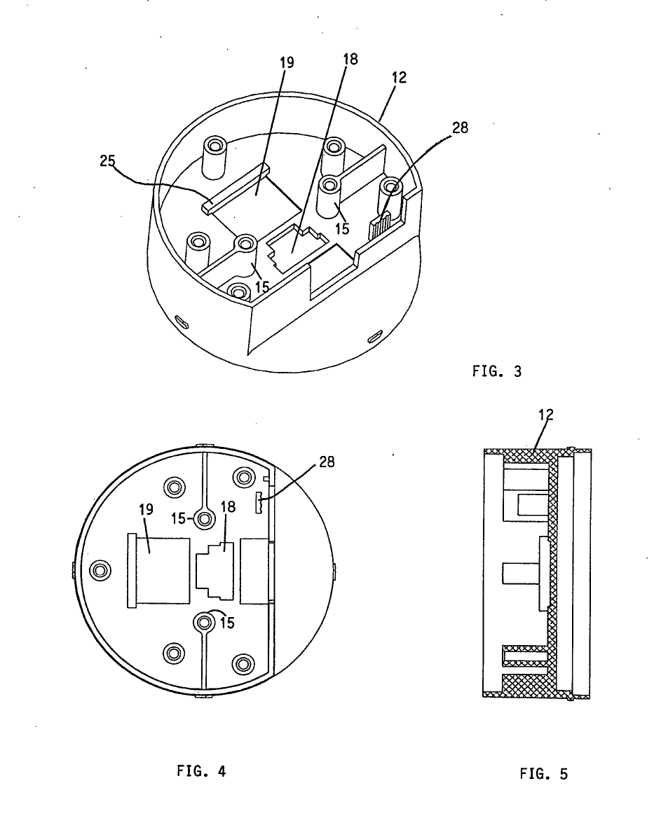

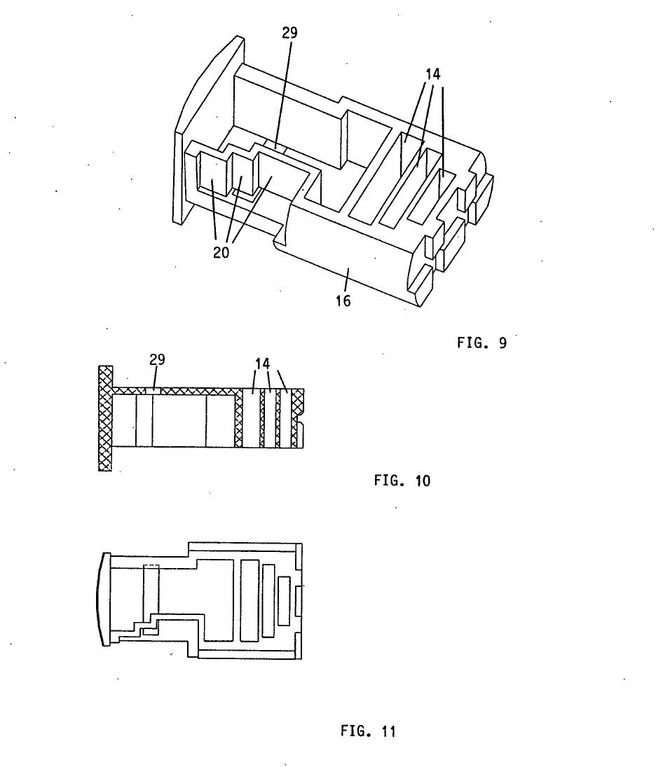

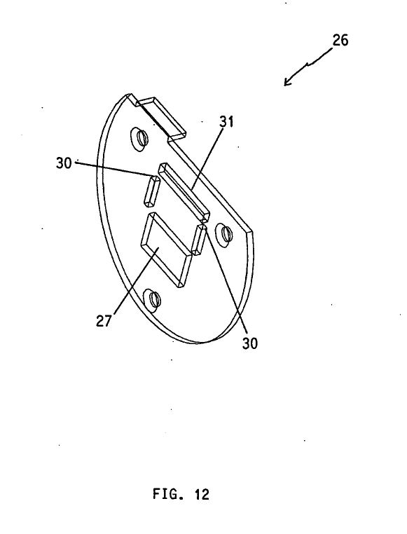

In FIGS. 1 to 12 of the accompanying drawings there is depicted schematically a metered dosage particulate condiment dispenser 10 hereinafter referred to as a salt shaker. The salt shaker 10 comprises a vessel 11 having a lid 9 attached removably at one end thereof and a dispensing head 12 attached removably at the other.

The dispensing head, which is typically fabricated as a moulded plastics component, comprises a step-shaped port 18 and a pair of guide pins 15 flanking the port 18. A trigger 13 has a pair of opposed curved side faces 16. The side faces bear against the guide pins 15 with sliding point contact dividing low sliding friction. That is, only the longitudinal centreline of each side face 16 engages with the inward facing vertical edges of the guide pins 15 as the trigger slides in and out.

The dispensing head of the salt shaker also includes a sink area 19 to reduce fictional contact between the trigger 13 and dispensing head 12. A stopper block 25 is formed integrally with the dispensing head 12 and provides a buffer against which the back end of the trigger bears to define its maximum depression position. As the trigger collides with this block, a shake effect insures complete dropout of the particulate material for dispensation.

The trigger 13 includes a number of metering compartments 14 ranging from small to large and extending from top to bottom through the trigger. The small metering compartment might correspond in volume to a “pinch of salt”, whereas the larger metering compartments (in combination with the smaller ones) might correspond in volume with a “teaspoon of salt” for example.

A pair of torsion spring 23 mounted upon respective spring posts 24 biases the trigger 13 forward. These torsion springs have tails as depicted engaging cuttings of the trigger. The use of torsion springs (as against compression coil springs for example) has the benefit of reducing spring operational noise, enabling longer distance travel of the trigger with only a small space required for the springs, and increased durability and repeated operability.

Near the front of the trigger 13 there is provided a plurality of steps 20. Alongside the steps and fixed firmly upon the head by a stopper guide 28 having high-friction serrations is a stopper 21 having a stopper pin 22. The user can slide the stopper 21 (against the holding friction of the serrations) to a selected position so that the stopper pin bears against a selected one of the steps 20 when the trigger is depressed. The dispensing head would be provided with markings (say “S” for Small, “M” for Medium and “L” for Large) alongside the stopper 21 so that the desired position can be set by the user.

A separator board 26 having a main dispensing aperture 27 is located between the cap 17 and the dispensing head 12. Metered dispensation of particulate material from one or more of the metering compartments occurs via the main dispensing aperture 27 as the compartments 14 are brought into alignment therewith upon depression of the trigger. The trigger also includes a dispensing chamber 29 extending from the top to the bottom of the trigger.

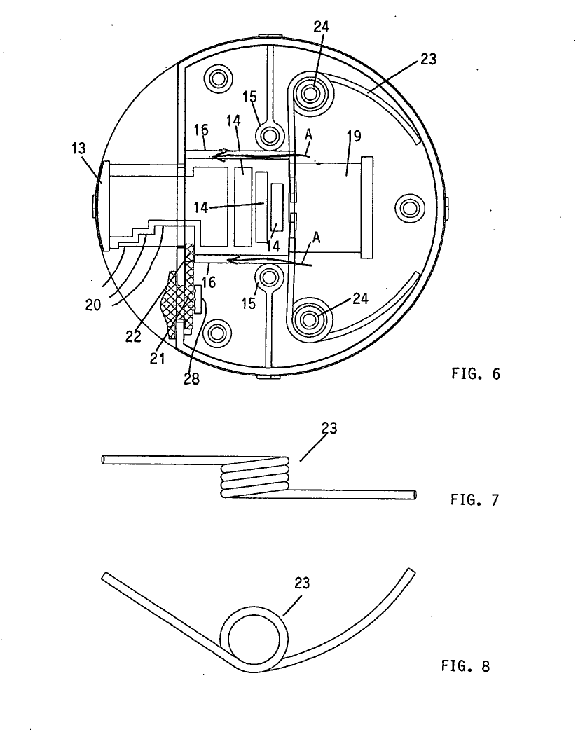

A rear dispensing aperture 31 is aligned with the dispensing chamber 29 and a pair of side dispensing apertures 30 laterally flank the trigger. As a result of repeated depression of the trigger 13, some salt (or other particulate condiment as the case may be) will escape around the trigger. To prevent the possibility of this escaped material from clogging the mechanism to the point that the trigger might be jammed by a build-up of the material, the curved nature of the faces 16 and the point contact made between these faces and the trigger guides 15 provides flow passages as indicated by arrows A in FIG. 6 to allow any such material to migrate along flow paths away from the sink area 19 from which it can then flow via the spaces alongside each curved wall 16 (upon repeated depression of the trigger) toward the side apertures 30 through which it is dispensed. Further, material that has escaped on top of the trigger can be dispensed through the dispensing chamber 29 of the trigger via the rear dispensing aperture 31.

A cap 17 is fitted upon the dispenser head 12 to prevent the unwanted ingress of humidity therepast to the vessel 11. This might be particularly useful where the dispenser is used to store salt, sugar or coffee grounds for example. The trigger is so configured with respect to the dispensing head that the trigger rests in a retracted position making it possible to fit a cap upon the dispensing head and thereby conceal the trigger and any openings in the dispensing head through which moist air might pass.

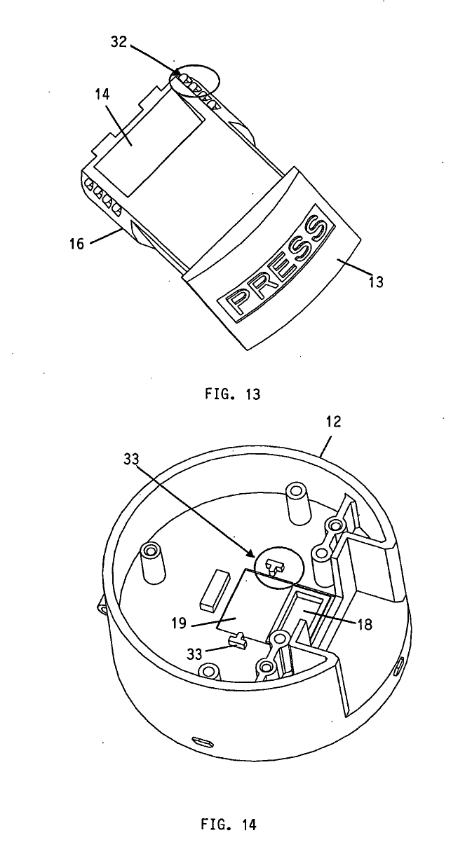

In FIG. 13 of the accompanying drawings, there is depicted schematically an alternative trigger 13. At the bottom edge of each curved side face 16 there is provided an array of the notches 32. The notches flank the dispensing compartments 14 as illustrated. The dispensing head 13 shown in FIG. 14 provides a pair of pawls 33 flanking the sink area 19. The pawls 33 interact with the notches 32 so that when the trigger 13 is depressed or released, it will vibrate to assist shaking the particulate material loose during dispensation to assist in preventing clogging.

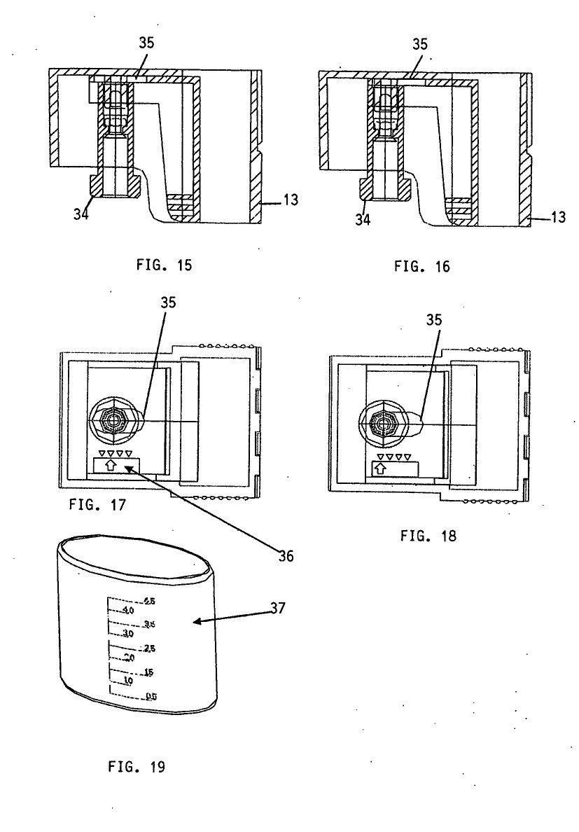

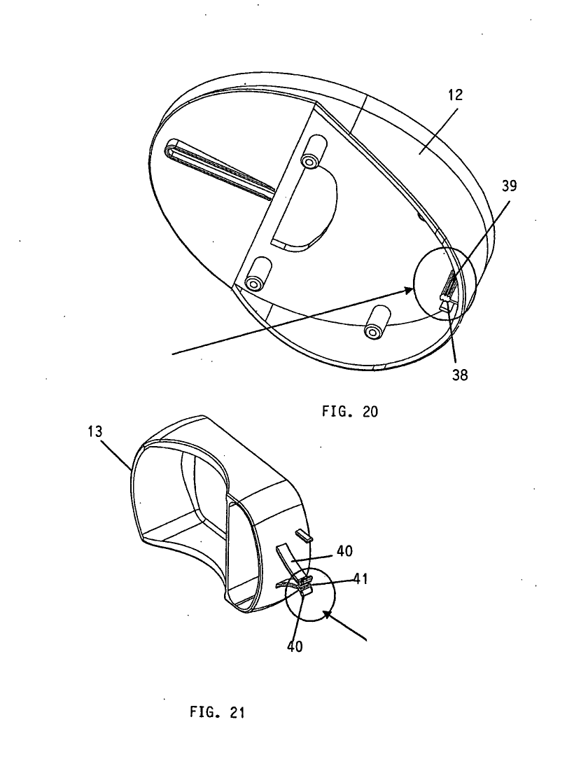

As a separate additional modification to the trigger, there is not provided a step arrangement like that depicted at 20 in FIG. 9 for example. Instead, a fixed dosage setting system is provided by the mechanism depicted in FIGS. 15 to 17. The mechanism comprises a knurled threaded post 34 that interacts with a sliding wall blade with slot 35 and volume markings 36. A metering beaker 37 is provided as shown in FIG. 19. The beaker 37 comprises volume markings as shown, which correspond with the volume markings 36. This DIY method requires the user to dump a required dosage of powder from another metering/weighing device into the beaker—say 0.5 grams of salt. The volume markings is then read off the beaker—say 430 cubic millimetres. The knurled post 34 is then adjusted to align the sliding wall blade with slot 35 with an appropriate marking 36. This sets the volume capacity of the metering compartment and once the adjustment is complete, the dispenser is “programmed” to dispensing 0.5 grams of salt upon each subsequent depression of the trigger.

An alternative vibration-inducing device is depicted in FIG. 20. In this device, there is provided upon the dispensing head 20 a post 38 having serrated edges 39. The trigger 13 comprises a pair of resilient clips 40 having inwardly facing serrations 41 that rub coarsely against the serrations 39 upon depression of the trigger 13. This causes vibrations in the trigger to dislodge particulate material for dispensation.

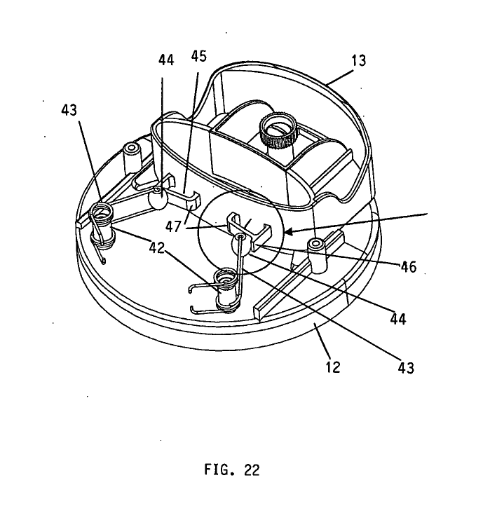

Rather than providing vibrations so to speak, an embodiment providing a single bump or shock is depicted in FIG. 22. In this embodiment, the dispensing head 13 is provided with a pair of spring posts 42—each supporting a torsion spring 43. The distal end of each torsion spring 43 has a ball-shaped wheel 44. At the back of the trigger 13 there is provided a pair of ramps 45. Each ramp has a limiting buffer 46 to prevent the wheels 44 from moving too far apart. The ramps 45 slope inwardly toward each other so that when the trigger is depressed, the wheels moved toward each other and bump off the end of the ramp against the back face of the trigger in between the ramps. Each inward end of the ramp has a curved corner 47 enabling the wheels to ride back onto the ramp when the trigger is released. When the wheels encounter the back face of the trigger, the trigger is caused to shake to thereby dislodge particulate material during dispensation.

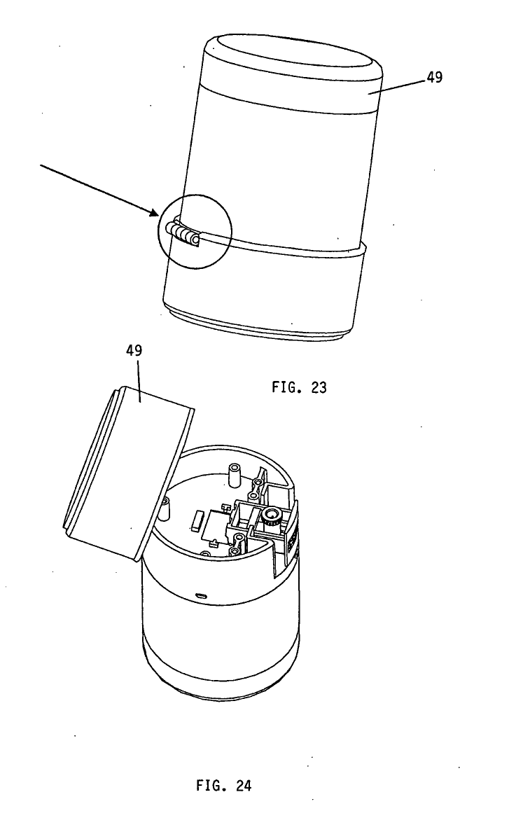

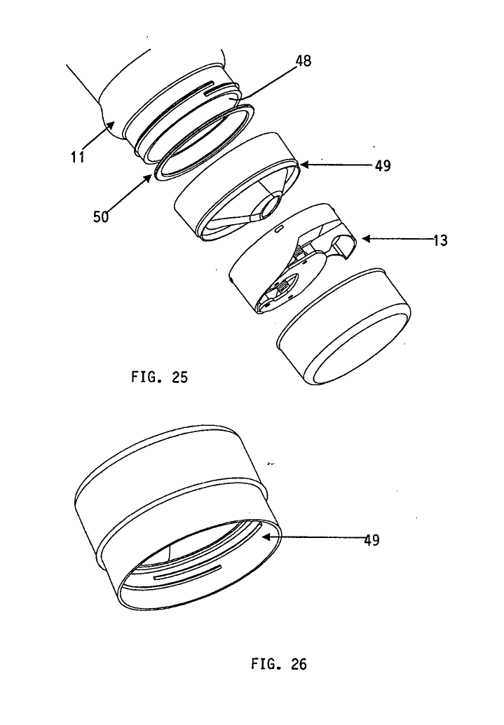

An unrelated modification to the device is shown in FIGS. 23 and 24. This modification is simply to provide a hinged cover 49 is shown in both closed and open configurations.

FIGS. 25 and 26 of the accompanying drawings depict an embodiment of the invention in which the condiment-containing vessel 11 is a glass or plastics jar having an externally threaded opening 48. An adapter ring 49 and rubber O-ring 50 provided as a means by which the jar 11 can be secured to the dispensing head 13. The adapter ring 49 has internal thread by which it can be screw-fixed upon the opening 48 in such manner as to tightly squeeze the rubber O-ring 50 in place therebetween.

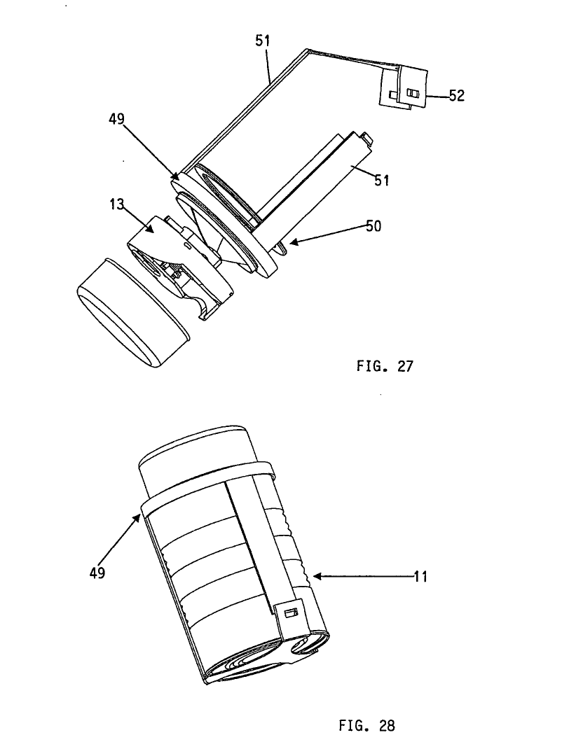

An alternative embodiment is depicted in FIGS. 27 and 28. In this embodiment, the vessel 11 takes the form of a metallic can. The dispensing head 13 is secured to the metallic can by an adapter ring 49 having clamping legs 51 extending therefrom. The clamping legs 51 snap-engage a 52 to encase the cam 11 in such manner that a sealing rubber O-ring 50 is secured against the opening of the can 11.

It should be appreciated that modifications and alterations obvious to those skilled in the art are not to be considered as beyond the scope of the present invention. For example, rather than providing curved faces 16 to provide point contact upon vertical guides 15, the opposed faces of the trigger might be flat angled surfaces, or simply be shaped with a longitudinal slot providing flow paths (arrows A) for excess/leaked particulate material toward the side dispensing apertures 30. Furthermore, the flat wall through which the trigger 13 extends could be curved in continuous alignment with the curved frontage of the trigger 13 if desired. Also, apart from use in storing and dispensing salt and other condiments, the dispenser could be used to store in an airtight manner coffee, sugar, protein powder, powdered milk, medicines and any other bulk flowable/particulate material.

1. A dispenser for particulate material, comprising:
a vessel for storing the particulate material,
a dispensing head attached to or formed integrally with the vessel, the dispensing head having a port communicating with the vessel,
a trigger movable with respect to the dispensing head and comprising a plurality of metering compartments that can be brought into alignment with the port upon depression of the trigger, the trigger having a number of steps formed thereon, and
a user-adjustable stopper mounted upon the dispensing head and configured to interact with the steps to selectively limit depression of the trigger to thereby align a selected one or more of said metering compartments with the port.

2. The dispenser of claim 1, wherein the dispensing head further comprises a dispensing path via which any excess particulate material can be dispensed.

3. The dispenser of claim 1, wherein the trigger is mounted to the dispensing head so as to slide linearly therein.

4. The dispenser of claim 2, wherein the dispensing head comprises a pair of fixed trigger guides, and the trigger has a pair of curved side faces that slide along the respective trigger guides.

5. The dispenser of claim 4, wherein the dispensing path includes spaces alongside the curved side faces.

6. The dispenser of claim 5, further comprising a separator board positioned beneath the trigger and comprising a main dispensing aperture to be aligned with the metering compartments and a pair of side dispensing apertures laterally flanking the trigger and aligned with the dispensing path spaces, and a rear dispensing aperture aligned with the dispensing chamber.

7. The dispenser of claim 3, wherein the dispensing head comprises a pair of posts onto which a pair of torsion springs are mounted, the springs biasing the trigger into a rest position.

8. The dispenser of claim 1, wherein the trigger rests in a retracted position making it possible to fit a cap upon the dispensing head and thereby conceal any openings in the dispensing head through which moist air might pass.

9. The dispenser of claim 1, further comprising a cap fitted upon the dispensing head.

10. The dispenser of claim 1, wherein the vessel is a jar having an externally threaded opening, and further comprising an adapter ring having an internal thread threadedly engaged by the opening of the jar and attached to the dispenser head.

11. The dispenser of claim 1, wherein the vessel is a can having an opening, and further comprising an adapter ring having a clamp for securing the adapter ring to the can, and attached to the dispenser head.

12. The dispenser of claim 10, or claim 11 further comprising a sealing ring captured between the adapter ring and the vessel.

13. A dispenser for particulate material, comprising:
a vessel for storing the particulate material,
a dispensing head attached to or formed integrally with the vessel, the dispensing head having a port communicating with the vessel,
a trigger movable with respect to the dispensing head and comprising a metering compartments that can be brought into alignment with the port upon depression of the trigger, and
means for inducing a vibration or shock in the trigger upon depression and/or release of the trigger to assist in dispensing the particulate material.

14. The dispenser of claim 13, wherein said means for inducing a vibration or shock comprises a plurality of notches upon the trigger and/or dispensing head and a pawl on the other of the trigger or dispensing head interacting with said plurality of notches to induce vibration in the trigger upon depression and/or release thereof.

15. The dispenser of claim 13, wherein said means for inducing a vibration or shock comprises a plurality of serrations upon the trigger and dispensing head interacting with one another to induce vibration in the trigger upon depression and/or release thereof.

16. The dispenser of claim 13, wherein said means for inducing a vibration or shock comprises a ramp on the trigger and a torsion spring mounted on the dispenser head and on which there is provided a wheel interacting with the ramp to ride off an end of the ramp and bump against the trigger upon depression of the trigger.

17. The dispenser of claim 13, wherein the vessel is a jar having an externally threaded opening, and further comprising an adapter ring having an internal thread threadedly engaged by the opening of the jar and attached to the dispenser head.

18. The dispenser of claim 13, wherein the vessel is a can having an opening, and further comprising an adapter ring having a clamp for securing the adapter ring to the can, and attached to the dispenser head.

19. The dispenser of claim 17, or claim 18 further comprising a sealing ring captured between the adapter ring and the vessel.

20. The dispenser of claim 13 further comprising a knurled threaded post that interacts with a sliding wall blade with a slot and volume markings.

21. In combination with the dispenser of claim 20, a metering beaker comprising volume markings, which correspond with the volume markings of the dispenser to enable the user to adjust the knurled post to align the sliding wall blade with an appropriate said dispenser marking, thereby setting a volume capacity of the metering compartment of the trigger for setting subsequent dispensing dosage size.
